(19) United States
(12) Patent Application Publication
(10) Pub. No.: US 2016/0237237 A1
(43) Pub. Date: Aug. 18, 2016

(54) GRAPHENE NANORIBBON-BASED GAS BARRIER COMPOSITES AND METHODS OF MAKING THE SAME

(71) Applicant: WILLIAM MARSH RICE UNIVERSITY, Houston, TX (US)

(72) Inventors: James M. Tour, Bellaire, TX (US); Changsheng Xiang, Houston, TX (US)

(73) Assignee: WILLIAM MARSH RICE UNIVERSITY, Houston, TX (US)

(21) Appl. No.: 15/024,560

(22) PCT Filed: Sep. 30, 2014
(86) PCT No.: PCT/US14/58342

§ 371 Date: Mar. 24, 2016

Related U.S. Application Data
(60) Provisional application No. 61/884,511, filed on Sep. 30, 2013.

(51) Int. Cl. C08K 3/04; C08L 75/04

(52) U.S. Cl. CPC C08K 3/04; C08L 75/04; C08K 2201/008

(57) ABSTRACT

In some embodiments, the present disclosure pertains to gas barrier composites that include a polymer matrix and graphene nanoribbons dispersed in the polymer matrix. The polymer matrix can include a phase-separated block copolymer with a hard phase domain and a soft phase domain. Like-wise, the functionalized graphene nanoribbons can include edge-functionalized graphene nanoribbons with concentrations that range from about 0.1% by weight to about 5% by weight of the gas barrier composites. In some embodiments, the present disclosure pertains to methods of making gas barrier composites by dispersing graphene nanoribbons in a polymer matrix. In some embodiments, the dispersing lowers the permeability of a gas through the gas barrier composite and causes phase separation of block copolymers in the polymer matrix. In some embodiments, the dispersion of graphene nanoribbons in the polymer matrix lowers the gas effective diffusivity of the gas barrier composite by three orders of magnitude.

### CROSS-REFERENCE TO RELATED APPLICATIONS

This application claims priority to U.S. Provisional Patent Application No. 61/884,511, filed on Sep. 30, 2013. The entirety of the aforementioned application is incorporated herein by reference.

### STATEMENT REGARDING FEDERALLY SPONSORED RESEARCH

This invention was made with government support under Air Force Research Laboratory Grant No. 09-S568-064-01-C1, awarded by the U.S. Department of Defense; Office of Naval Research Grant No. N00014-09-1066, awarded by the U.S. Department of Defense; and Air Force Office of Scientific Research Grant No. FA9550-12-1-0035, awarded by the U.S. Department of Defense. The government has certain rights in the invention.

### BACKGROUND

Current gas barrier materials suffer from numerous limitations, including non-optimal gas permeability and high filler concentrations that affect transparency. Moreover, many of the current methods of making such gas barrier materials are not scalable. Various embodiments of the present disclosure address these limitations.

### SUMMARY

In some embodiments, the present disclosure pertains to gas barrier composites that include a polymer matrix and graphene nanoribbons dispersed in the polymer matrix. In some embodiments, the graphene nanoribbons have an isotropic arrangement in the polymer matrix. In some embodiments, the graphene nanoribbons have an anisotropic arrangement in the polymer matrix.

In some embodiments, the polymer matrix includes a phase-separated block copolymer. In some embodiments, the phase-separated block copolymer includes a hard phase domain and a soft phase domain. In some embodiments, the polymer matrix includes, without limitation, styrenic block copolymers, polyolefin blends, elastomeric alloys, thermoplastic polyurethanes, poly(esters), thermoplastic co-poly(esters), thermoplastic polyamides, poly(vinyl alcohol), polyethylene terephthalate, polyethylene, polypropylene, high density polyethylene, poly(ethers), co-polymers thereof, block co-polymers thereof, and combinations thereof. In some embodiments, the polymer matrix includes thermoplastic polyurethane.

In some embodiments, the graphene nanoribbons of the present disclosure are derived from carbon nanotubes through the longitudinal splitting of carbon nanotubes. In some embodiments, the graphene nanoribbons include functionalized graphene nanoribbons. In some embodiments, the functionalized graphene nanoribbons include, without limitation, edge-functionalized graphene nanoribbons, polymer-functionalized graphene nanoribbons. alkyl-functionalized graphene nanoribbons, and combinations thereof. In some embodiments, the graphene nanoribbons include hexadecylated-graphene nanoribbons (HD-GNRs).

In some embodiments, the graphene nanoribbons include from about 0.1% by weight to about 5% by weight of the gas barrier composites of the present disclosure. In some embodiments, the graphene nanoribbons include about 0.5% by weight of the gas barrier composites.

In some embodiments, the gas barrier composites of the present disclosure display impermeability to a gas that includes, without limitation, air, N₂, H₂, O₂, CH₄, CO₂, natural gas, H₂S, and combinations thereof. In some embodiments, the gas barrier composites of the present disclosure have a gas effective diffusivity (D_{eff}) that ranges from about 1×10⁻³ m²/s to about 5×10⁻³ m²/s. In some embodiments, the gas barrier composites of the present disclosure have a gas effective diffusivity (D_{eff}) that is about 3×10⁻³ m²/s.

In some embodiments, the gas barrier composites of the present disclosure have a transparency of more than about 50%. In some embodiments, the gas barrier composites of the present disclosure are in the form of a film.

In some embodiments, the present disclosure pertains to methods of making gas barrier composites by dispersing graphene nanoribbons in a polymer matrix. In some embodiments, the dispersing lowers permeability of a gas (e.g., N₂) through the gas barrier composite. In some embodiments where the polymer matrix includes a block copolymer, the dispersing causes phase separation of the block copolymer. In some embodiments, the dispersing causes phase separation of the block copolymer into a soft phase domain and a hard phase domain.

In some embodiments, the dispersion of graphene nanoribbons in the polymer matrix lowers the gas effective diffusivity (D_{eff}) of the gas barrier composite by at least three orders of magnitude. In some embodiments, the dispersion of graphene nanoribbons in the polymer matrix lowers a gas effective diffusivity (D_{eff}) of the gas barrier composite to a value that ranges from about 1×10⁻³ m²/s to about 5×10⁻³ m²/s.

### DESCRIPTION OF THE FIGURES

FIG. 1 provides a scheme of a method of making gas barrier composites.

FIG. 2 provides chemical structures of graphene oxide (GO) (FIG. 2A); graphene nanoribbons (GNRs) (FIG. 2B); and hexadecylated-GNRs (HD-GNRs) (FIG. 2C). FIG. 2D shows the Raman spectra of GO and HD-GNRs. FIG. 2E shows a dispersion study of GNRs (left) and HD-GNRs (right) in chloroform (1 mg/mL).

FIG. 3 provides various images of HD-GNRs and their precursors. FIG. 3A is a scanning electron microscopy (SEM) image of multi-walled carbon nanotubes (MWNTs). FIG. 3B is an SEM image of HD-GNRs. FIG. 3C is an atomic force microscopy (AFM) image of HD-GNRs in stacked form. The inset height profile indicates that the vertical distance was 36 FIG. 3D shows a transmission electron microscopy (TEM) image of stacked HD-GNRs on a copper grid.

FIG. 4 shows various images of gas barrier composites that include thermoplastic polyurethane (TPU) and HD-GNRs (referred to as TPU/HD-GNRs composite films). FIG. 4A shows an SEM image of a cross-section of a TPU/5 wt % HD-GNRs film after cutting with a razor blade. FIG. 4B shows a high resolution image of FIG. 4A.

FIG. 5 shows SEM images of TPU/HD-GNRs composite films with HD-GNRs at 0 wt % (FIG. 5A); 0.05 wt % (FIG. 5B); 0.2 wt % (FIG. 5C); 0.5 wt % (FIG. 5D); 1 wt % (FIG. 5E); 2 wt % (FIG. 5F); 3 wt % (FIG. 5G); and 5 wt % (FIG. 5H). All scale bars are 10 μm.

FIG. 6 shows various data relating to the characterization of TPU/HD-GNRs composite films. FIG. 6A shows fourier transform infrared spectroscopy (FTIR) spectra of TPU and TPU/HD-GNRs composite films. FIG. 6B shows thermogravimetric analysis (TGA) measurements of HD-GNRs and TPU/HD-GNRs composite films. TPU with 2 and 3 wt % HD-GNRs were eliminated from the figure since they almost overlapped with 1 and 5 wt % curves, thereby complicating the plot.

FIG. 7 shows data relating to the mechanical properties of TPU/HD-GNRs composite films. FIG. 7A shows stress-strain curves of TPU and TPU/HD-GNRs composite films. FIG. 7B shows a summary of the tensile moduli of different samples. FIG. 7C shows the storage moduli of TPU and TPU/HD-GNRs composite films as a function of temperature. FIG. 7D shows a damping factor (Tan δ) of TPU and TPU/HD-GNRs composite films as a function of temperature.

FIG. 8 shows data relating to the pressure drop of TPU/HD-GNRs composite films. FIG. 8A shows a pressure drop of TPU and TPU/HD-GNRs films with respect to time. FIG. 8B shows a pressure drop of TPU/0.5 wt % HD-GNRs composite film over a longer time period.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Polymer-based films with low gas permeability have various applications, including applications in food packaging and light-weight mobile gas storage containers. Impermeable materials have been added into a polymer matrix in order to decrease the gas permeability of the polymer matrix.

For instance, graphene has been used as impermeable materials in various composites. Graphene is a two dimensional atomically thin carbon framework that possesses optimal electrical, mechanical and thermal properties. Graphene can be either derived from top-down methods (such as mechanical exfoliation) or bottom-up chemical vapor deposition methods. However, neither of the two approaches has been scaled to large quantities that are needed for composite applications.

Graphene oxide (GO) has also been used as impermeable materials in various composites. In fact, GO has been used as a substitute for graphene due to its similar (though more highly oxidized) structure, its affordability, and potential for large scale synthesis. Furthermore, pure GO and its composite films have been shown to have improved gas barrier properties.

However, the structure of GO includes many defects and holes that allow gas permeation. Furthermore, GO is unstable to water. In addition, GO slowly degrades to small humic acid structures while generating acid. Therefore, GO does not provide the same permeability as graphene.

Moreover, many existing filler materials (including graphene, GO and nanoclays) need to be present at high concentrations in various composites in order to have a suitable gas permeability effect. Such high filler concentrations can in turn decrease the transparency of composites, thereby making the composites unsuitable for various applications.

As such, a need exists for the development of improved gas barrier composites that can prevent gas permeability in a more effective manner at lower filler concentrations. Moreover, a need exists for methods of making such gas barrier composites in a scalable manner. The present disclosure addresses these needs.

In some embodiments, the present disclosure pertains to gas barrier composites that include a polymer matrix and graphene nanoribbons dispersed in the polymer matrix. In some embodiments, the present disclosure pertains to methods of making the aforementioned gas barrier composites.

Gas Barrier Composites

The gas barrier composites of the present disclosure generally include a polymer matrix and graphene nanoribbons dispersed in the polymer matrix. In some embodiments, the gas barrier composites of the present disclosure consist essentially of graphene nanoribbons and a polymer matrix. In some embodiments, the gas barrier composites of the present disclosure lack graphene oxides. In some embodiments, the gas barrier composites of the present disclosure lack nanoclays. In some embodiments, the gas barrier composites of the present disclosure also include nanoclays.

As set forth in more detail herein, various polymer matrices and graphene nanoribbons may be utilized in the gas barrier composites of the present disclosure at various concentrations. Moreover, the gas barrier composites of the present disclosure may display various levels of impermeability to various gases. Furthermore, the gas barrier composites of the present disclosure may have various enhanced mechanical properties.

Polymer Matrix

The gas barrier composites of the present disclosure may include various polymer matrices. For instance, in some embodiments, polymer matrices include block copolymers. Block copolymers generally refer to polymers with two or more types of polymer blocks. For instance, in some embodiments, block copolymers in polymer matrices can include di-blocks, tri-blocks, and tetra-blocks. In some embodiments, block copolymers in polymer matrices can include branched blocks. In some embodiments, block copolymers in polymer matrices include linear blocks.

In some embodiments, the polymer matrices of the present disclosure include phase-separated block copolymers. In some embodiments, the phase-separated block copolymers in polymer matrices include two or more polymer blocks that phase-separate into two or more phase domains. In some embodiments, the phase domains can include, without limitation, hard phase domains, soft phase domains, crystalline phase domains, hydrogen bonded phase domains, π-π stacked phase domains, hydrophilic phase domains, hydrophobic phase domains, and non-crystalline phase domains.

In some embodiments, the polymer matrices of the present disclosure include phase-separated block copolymers that include a hard phase domain and a soft phase domain. In some embodiments, the soft phase domain includes polymer chains (e.g., long chain polyesters or polyether diols). In some embodiments, the hard phase domain includes linker molecules (e.g., diisocyanates and short chain extender molecules).

In some embodiments, the polymer matrices of the present disclosure include, without limitation, rubbers, elastomers, plastics, and combinations thereof. In some embodiments, the polymer matrices of the present disclosure are retarded from undergoing explosive decompression during depressurization.

In some embodiments, the polymer matrices of the present disclosure include thermoplastic elastomers. In some embodiments, the thermoplastic elastomers include, without limitation, styrenic block copolymers, polyolefin blends, elastomeric alloys, thermoplastic polyurethanes, thermoplastic co-polyesters, thermoplastic polyamides, and combinations thereof.

In some embodiments, the polymer matrices of the present disclosure include, without limitation, poly(vinyl alcohol), polyethylene terephthalate, polyethylene, polypropylene, high density polyethylene, thermoplastic polyurethane, poly(esters), poly(ethers), co-polymers thereof, block co-polymers thereof, and combinations thereof. In some embodiments, the polymer matrices of the present disclosure include thermoplastic polyurethane.

Graphene Nanoribbons

The gas barrier composites of the present disclosure may also include various graphene nanoribbons. For instance, in some embodiments, the graphene nanoribbons may include, without limitation, doped graphene nanoribbons, functionalized graphene nanoribbons, reduced graphene oxide nanoribbons, and combinations thereof.

In some embodiments, the graphene nanoribbons of the present disclosure include functionalized graphene nanoribbons. In some embodiments, the functionalized graphene nanoribbons include, without limitation, edge-functionalized graphene nanoribbons, polymer-functionalized graphene nanoribbons, alkyl-functionalized graphene nanoribbons, and combinations thereof.

In some embodiments, the graphene nanoribbons of the present disclosure include polymer-functionalized graphene nanoribbons. In some embodiments, the polymer-functionalized graphene nanoribbons are edge-functionalized. In some embodiments, the polymer-functionalized graphene nanoribbons are functionalized with polymers that include, without limitation, vinyl polymers, polyethylene, polystyrene, polyvinyl chloride, polyvinyl acetate, polyvinyl alcohol, polyacrylonitrile, and combinations thereof. In some embodiments, the polymer-functionalized graphene nanoribbons are functionalized with polyethylene oxide. In some embodiments, the polymer-functionalized graphene nanoribbons are functionalized with poly(ethylene oxides) (also known as poly(ethylene glycols)). In some embodiments, the polymer-functionalized graphene nanoribbons may include polyethylene oxide-functionalized graphene nanoribbons (PEO-GNRs).

In some embodiments, the graphene nanoribbons of the present disclosure include alkyl-functionalized graphene nanoribbons. In some embodiments, the alkyl-functionalized graphene nanoribbons are functionalized with alkyl groups that include, without limitation, hexadecyl groups, octyl groups, butyl groups, and combinations thereof. In some embodiments, alkyl-functionalized graphene nanoribbons include hexadecylated-graphene nanoribbons (HD-GNRs).

The graphene nanoribbons of the present disclosure may have various structures. For instance, in some embodiments, the graphene nanoribbons of the present disclosure have a flattened structure. In some embodiments, the graphene nanoribbons of the present disclosure have a foliated structure. In some embodiments, the graphene nanoribbons of the present disclosure have a stacked structure.

The graphene nanoribbons of the present disclosure may also have various layers. For instance, in some embodiments, the graphene nanoribbons of the present disclosure include a single layer. In some embodiments, the graphene nanoribbons of the present disclosure include a plurality of layers. In some embodiments, the graphene nanoribbons of the present disclosure include from about 1 layer to about 100 layers. In some embodiments, the graphene nanoribbons of the present disclosure have from about 20 layers to about 80 layers. In some embodiments, the graphene nanoribbons of the present disclosure have from about 2 layers to about 50 layers. In some embodiments, the graphene nanoribbons of the present disclosure include from about 2 layers to about 10 layers. In some embodiments, the graphene nanoribbons of the present disclosure have from about 1 layer to about 4 layers. In some embodiments, the graphene nanoribbons of the present disclosure have from about 1 layer to about 3 layers.

The graphene nanoribbons of the present disclosure may also have various sizes. For instance, in some embodiments, the graphene nanoribbons of the present disclosure include widths ranging from about 100 nm to about 500 nm. In some embodiments, the graphene nanoribbons of the present disclosure include widths ranging from about 200 nm to about 300 nm.

In some embodiments, the graphene nanoribbons of the present disclosure include lengths ranging from about 50 nm to about 100 μm. In some embodiments, the graphene nanoribbons of the present disclosure include lengths ranging from about 150 nm to about 10 μm. In some embodiments, the graphene nanoribbons of the present disclosure include lengths ranging from about 150 nm to about 1 μm. In some embodiments, the graphene nanoribbons of the present disclosure include lengths ranging from about 150 nm to about 500 nm. In some embodiments where graphene nanoribbons are derived from carbon nanotubes, the lengths of the graphene nanoribbons correspond to the lengths of the precursor carbon nanotubes.

In some embodiments where the graphene nanoribbons of the present disclosure are stacked, the stacked graphene nanoribbons have thicknesses ranging from about 10 nm to about 100 nm. In some embodiments, the stacked graphene nanoribbons of the present disclosure have thicknesses ranging from about 25 nm to about 50 nm. In some embodiments, the stacked graphene nanoribbons of the present disclosure have thicknesses of about 40 nm.

The graphene nanoribbons of the present disclosure may also be in various states. For instance, in some embodiments, the graphene nanoribbons of the present disclosure may be substantially free of defects. In some embodiments, the graphene nanoribbons of the present disclosure are non-oxidized.

Graphene Nanoribbon Fabrication

The graphene nanoribbons of the present disclosure may be derived from various sources. For instance, in some embodiments, the graphene nanoribbons of the present disclosure may be derived from carbon nanotubes, such as multi-walled carbon nanotubes. In some embodiments, the graphene nanoribbons of the present disclosure are derived through the longitudinal splitting (or “unzipping”) of carbon nanotubes.

Various methods may be used to split (or “unzip”) carbon nanotubes to form graphene nanoribbons. In some embodiments, carbon nanotubes may be split by exposure to potassium, sodium, lithium, alloys thereof, metals thereof, salts thereof, and combinations thereof. For instance, in some embodiments, the splitting may occur by exposure of the carbon nanotubes to a mixture of sodium and potassium alloys, a mixture of potassium and naphthalene solutions, and combinations thereof. In some embodiments, the graphene nanoribbons of the present disclosure are made by the longitudinal splitting of carbon nanotubes using oxidizing agents (e.g., KMnO₄). In some embodiments, the graphene nanoribbons of the present disclosure are made by the longitudinal opening of carbon nanotubes (e.g., multi-walled carbon nanotubes) through in situ intercalation of Na/K alloys into the carbon nanotubes. In some embodiments, the intercalation may be followed by quenching with a functionalizing agent (e.g., 1-iodohexadecane) to result in the production of functionalized graphene nanoribbons (e.g., HD-GNRs).

Additional variations of such embodiments are described in U.S. Provisional Application No. 61/534,553 entitled “One Pot Synthesis of Functionalized Graphene Oxide and Polymer/Graphene Oxide Nanocomposites.” Also see PCT/US2012/055414, entitled “Solvent-Based Methods For Production Of Graphene Nanoribbons.” Also see Higginbotham et al., “Low-Defect Graphene Oxide Oxides from Multiwalled Carbon Nanotubes,” ACS Nano 2010, 4, 2059-2069. Also see Applicants' co-pending U.S. patent application Ser. No. 12/544,057 entitled “Methods for Preparation of Graphene Oxides From Carbon Nanotubes and Compositions, Thin Composites and Devices Derived Therefrom.” Also see Kosynkin et al., “Highly Conductive Graphene Oxides by Longitudinal Splitting of Carbon Nanotubes Using Potassium Vapor,” ACS Nano 2011, 5, 968-974. Also see WO 2010/14786A1.

Graphene Nanoribbon Concentrations

The gas barrier composites of the present disclosure can include various concentrations of graphene nanoribbons. For instance, in some embodiments, the gas barrier composites of the present disclosure include graphene nanoribbon concentrations that range from about 0.01% by weight to about 10% by weight of the gas barrier composite. In some embodiments, the gas barrier composites of the present disclosure include graphene nanoribbon concentrations that range from about 0.1% by weight to about 1% by weight of the gas barrier composite. In some embodiments, the gas barrier composites of the present disclosure include graphene nanoribbon concentrations of about 0.5% by weight of the gas barrier composite. In some embodiments, the gas barrier composites of the present disclosure include graphene nanoribbon concentrations of about 0.05%, 0.1%, 0.2%, 0.5%, 1%, 2%, 3%, or 5% by weight of the gas barrier composite.

Graphene Nanoribbon Arrangements

The gas barrier composites of the present disclosure can include graphene nanoribbons in various arrangements. For instance, in some embodiments, the graphene nanoribbons of the present disclosure are uniformly dispersed in a polymer matrix. In some embodiments, the graphene nanoribbons of the present disclosure lack any aggregates in a polymer matrix. In some embodiments, the graphene nanoribbons of the present disclosure lack any bundles in a polymer matrix.

In some embodiments, the graphene nanoribbons of the present disclosure have a disordered (i.e., isotropic) arrangement in a polymer matrix. In some embodiments, the graphene nanoribbons of the present disclosure have an ordered (i.e., anisotropic) arrangement in a polymer matrix.

Gas Impermeability

The gas barrier composites of the present disclosure can display impermeability to a gas. In some embodiments, the gas includes, without limitation, air, N₂, H₂, O₂, CH₄, CO₂, natural gas, H₂S, and combinations thereof. In some embodiments, the gas includes N₂.

The gas barrier composites of the present disclosure can display various levels of impermeability to a gas. For instance, in some embodiments, the impermeability of gas barrier composites to a gas ranges from about 50% to about 100%. In some embodiments, the impermeability of gas barrier composites to a gas ranges from about 75% to about 100%. In some embodiments, the impermeability of gas barrier composites to a gas is more than about 50%. In some embodiments, the impermeability of gas barrier composites to a gas is more than about 90%.

In some embodiments, the gas barrier composites of the present disclosure have a gas effective diffusivity (D_{eff}) that ranges from about 0.5×10⁻⁶ m²/s to about 5×10⁻³ m²/s. In some embodiments, the gas barrier composites of the present disclosure have a gas effective diffusivity (D_{eff}) that ranges from about 0.5×10⁻⁶ m²/s to about 2×10⁻⁶ m²/s. In some embodiments, the gas barrier composites of the present disclosure have a gas effective diffusivity (D_{eff}) that ranges from about 1×10⁻³ m²/s to about 5×10⁻³ m²/s. In some embodiments, the gas barrier composites of the present disclosure have a gas effective diffusivity (D_{eff}) of about 3×10⁻³ m²/s. In some embodiments, the gas barrier composites of the present disclosure have a gas effective diffusivity (D_{eff}) of about 3×10⁻³ m²/s.

Properties

The gas barrier composites of the present disclosure can have various advantageous properties. For instance, in some embodiments, the gas barrier composites of the present disclosure are transparent. In some embodiments, the gas barrier composites of the present disclosure have transparencies ranging from about 40% to about 100%. In some embodiments, the gas barrier composites of the present disclosure have transparencies ranging from about 75% to about 100%. In some embodiments, the gas barrier composites of the present disclosure have transparencies of more than about 50%. In some embodiments, the gas barrier composites of the present disclosure have transparencies of more than about 90%.

In some embodiments, the gas barrier composites of the present disclosure have high transparencies when graphene nanoribbons in the gas barrier composites have few layers. For instance, in some embodiments, the gas barrier composites of the present disclosure have transparencies of more than about 50% when they include graphene nanoribbons that have from about 1 layer to about 4 layers. In some embodiments, the gas barrier composites of the present disclosure have transparencies of more than about 90% when they include graphene nanoribbons that have from about 1 layer to about 3 layers.

The gas barrier composites of the present disclosure can also have advantageous mechanical properties. For instance, in some embodiments, the gas barrier composites of the present disclosure have storage moduli ranging from about 5 MPa to about 100 MPa. In some embodiments, the gas barrier composites of the present disclosure have storage moduli ranging from about 5 MPa to about 50 MPa.

In some embodiments, the gas barrier composites of the present disclosure have a Tan δ (loss modulus/storage modulus) value ranging from about 0.05 to about 0.5. In some embodiments, the gas barrier composites of the present disclosure have a Tan δ value ranging from about 0.05 to about 0.15.

In some embodiments, the gas barrier composites of the present disclosure have a tensile modulus ranging from about 5 MPa to about 1000 MPa. In some embodiments, the gas barrier composites of the present disclosure have a tensile modulus ranging from about 20 MPa to about 1000 MPa. In some embodiments, the gas barrier composites of the present disclosure have a tensile modulus ranging from about 100 MPa to about 1000 MPa. In some embodiments, the gas barrier composites of the present disclosure have a tensile modulus ranging from about 20 MPa to about 100 MPa. In some embodiments, the gas barrier composites of the present disclosure have a tensile modulus ranging from about 5 MPa to about 15 MPa.

Shapes

The gas barrier composites of the present disclosure can also have various shapes. For instance, in some embodiments, the gas barrier composites of the present disclosure are in the form of a film. In some embodiments, the films may be in the form of squares, circles, triangles, spherical tanks, cylinders, or combinations thereof. In some embodiments, the films may have a thickness ranging from about 50 μm to about 100 mm. In some embodiments, the films may have a thickness of about 50 μm.

In some embodiments, the gas barrier composites of the present disclosure may be conformed to a desired shape. For instance, in some embodiments, the gas barrier composites of the present disclosure may be conformed to a desired shape for high form factors.

Methods of Making Gas Barrier Composites

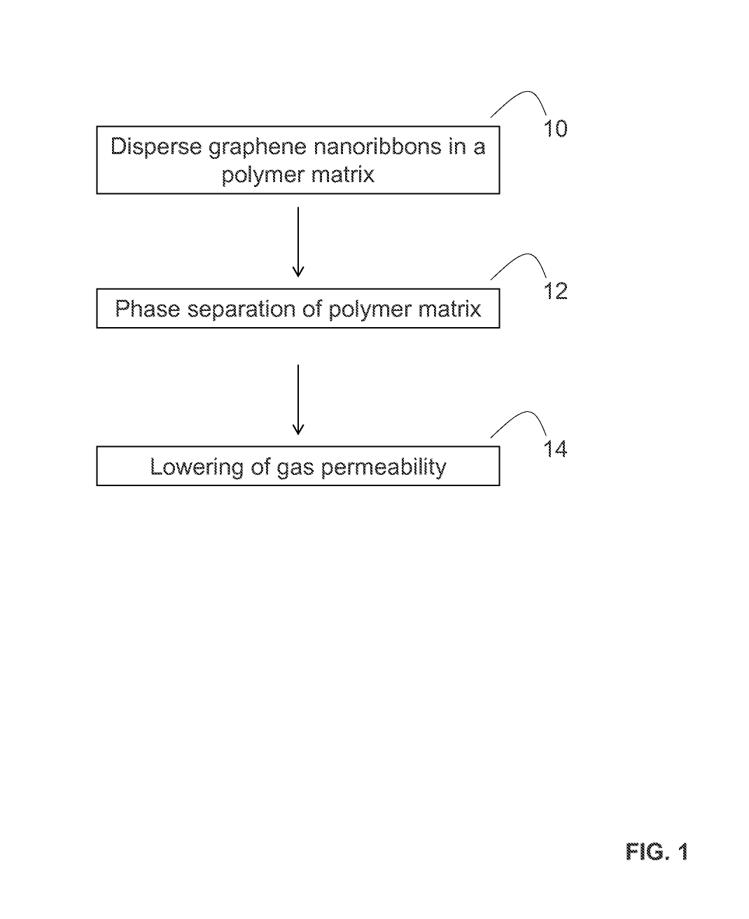

In some embodiments, the present disclosure pertains to methods of making the gas barrier composites of the present disclosure. In some embodiments illustrated in FIG. 1, such methods include dispersing graphene nanoribbons in a polymer matrix (step 10). In some embodiments, the dispersing results in the phase separation of the polymer matrix (step 12). In some embodiments, the dispersing lowers permeability of a gas (e.g., N₂) through the gas barrier composite (step 14).

As set forth previously, various graphene nanoribbons may be dispersed in various polymer matrices to form various types of gas barrier composites with various graphene nanoribbon concentrations. Moreover, as set forth in more detail herein, various methods may be utilized to disperse graphene nanoribbons in polymer matrices. As also set forth in more detail herein, the dispersion of graphene nanoribbons in polymer matrices may have various effects on the formed gas barrier composites.

Dispersion of Graphene Nanoribbons in Polymer Matrices

Various methods may be utilized to disperse graphene nanoribbons in polymer matrices. For instance, in some embodiments, the dispersion can occur by methods that include, without limitation, blending, stirring, thermal melting, layering, extrusion, sonication, solution casting, shearing, and combinations thereof.

In some embodiments, the dispersion of graphene nanoribbons in polymer matrices occurs by solution casting. In some embodiments, the dispersion of graphene nanoribbons in polymer matrices occurs by blending. In some embodiments, the blending includes, without limitation, twin screw blending, rotating screw blending, high shear blending, and combinations thereof.

In some embodiments, the dispersion of graphene nanoribbons in polymer matrices occurs by shearing. In some embodiments, the shearing can be applied through stretching, spinning or thinning of the host.

In some embodiments, the dispersion of graphene nanoribbons in a polymer matrix results in the formation of a disordered (i.e., isotropic) arrangement of graphene nanoribbons in the polymer matrix. In some embodiments, the dispersion of graphene nanoribbons in a polymer matrix results in the formation of an ordered (i.e., anisotropic) arrangement in the polymer matrix. In some embodiments, the ordered arrangement forms through the application of shear stress (e.g., stretching, spinning or thinning of the host).

Phase Separation

In some embodiments, the dispersion of graphene nanoribbons in polymer matrices can cause phase separation of the polymer matrices. For instance, in some embodiments where the polymer matrix includes a block copolymer (as previously described), the dispersing causes phase separation of the block copolymer. In some embodiments, the dispersing causes phase separation of the hard phase domains and the soft phase domains of the block copolymer.

Lowering of Gas Permeability

In some embodiments, the dispersion of graphene nanoribbons in polymer matrices can lower the gas permeability of the gas barrier composite. For instance, in some embodiments, the dispersion of graphene nanoribbons in the polymer matrix lowers the gas effective diffusivity (D_{eff}) of the gas barrier composite by at least three orders of magnitude. In some embodiments, the dispersion of graphene nanoribbons in polymer matrices can lower the gas permeability of the gas barrier composite without a pressure drop.

In some embodiments, the dispersion of graphene nanoribbons in polymer matrices can lower the gas permeability of the gas barrier composite by about 10% to about 100%. In some embodiments, the dispersion of graphene nanoribbons in polymer matrices can lower the gas permeability of the gas barrier composite by about 10% to about 75%. In some embodiments, the dispersion of graphene nanoribbons in polymer matrices can lower the gas permeability of the gas barrier composite by about 50% to about 75%. In some embodiments, the dispersion of graphene nanoribbons in polymer matrices can lower the gas permeability of the gas barrier composite by about 75% to about 100%.

In some embodiments, the dispersion of graphene nanoribbons in polymer matrices can lower the gas effective diffusivity (D_{eff}) of the gas barrier composite to a value that ranges from about 0.5×10⁻⁶ m²/s to about 5×10⁻³ m²/s. In some embodiments, the dispersion of graphene nanoribbons in polymer matrices can lower the gas effective diffusivity (D_{eff}) of the gas barrier composite to a value that ranges from about 0.5×10⁻⁶ m²/s to about 2×10⁻⁶ m²/s. In some embodiments, the dispersion of graphene nanoribbons in polymer matrices can lower the gas effective diffusivity (D_{eff}) of the gas barrier composite to a value that ranges from about 1×10⁻³ m²/s to about 5×10⁻³ m²/s. In some embodiments, the dispersion of graphene nanoribbons in polymer matrices can lower the gas effective diffusivity (D_{eff}) of the gas barrier composite to a value of about 3×10⁻³ m²/s.

Shaping of Gas Barrier Composites

In some embodiments, the gas barrier composites of the present disclosure can be fabricated into a desired shape. For instance, in some embodiments, a solution containing polymer matrices and graphene nanoribbons may be poured into a mold that contains a desired shape (e.g., a cylinder). In some embodiments, the solution may then be dried until a gas barrier composite with a suitable shape is formed.

Bulk Fabrication

In some embodiments, the methods of the present disclosure can be utilized for the bulk fabrication of gas barrier composites. For instance, in some embodiments, the methods of the present disclosure can be utilized to make from about 0.1 g to about 1 ton of gas barrier composites. In some embodiments, the methods of the present disclosure can be utilized to make from about 0.1 g to about 100 kg of gas barrier composites. In some embodiments, the methods of the present disclosure can be utilized to make from about 1 g to about 1 kg of gas barrier composites. In some embodiments, the methods of the present disclosure can be utilized to make from about 5 g to about 10 g of gas barrier composites.

Advantages and Applications

The gas barrier composites of the present disclosure provide various advantages over prior composites. For instance, unlike graphene oxide, graphene nanoribbons are stable in water. Moreover, graphene nanoribbons can be edge-functionalized to improve processability without sacrificing the integrity of the basal planes. Furthermore, graphene nanoribbons (especially in edge-functionalized form) are more dispersible in the gas barrier composites of the present disclosure than other fillers, such as graphene oxides and nanoclays. Accordingly, the gas barrier composites of the present disclosure demonstrate high gas barrier efficiencies at much lower filler (i.e., graphene nanoribbon) concentrations.

In addition, graphene nanoribbons can improve the mechanical properties of the gas barrier composites of the present disclosure in various ways. For instance, in some embodiments, graphene nanoribbons in the gas barrier composites of the present disclosure can reinforce the polymer matrix by causing phase separation of the polymer matrix. Such effects can in turn enhance the thermal stability, storage modulus, and glass transition temperature (Tg) of the gas barrier composites of the present disclosure.

Furthermore, the methods of the present disclosure can be utilized for the bulk fabrication of gas barrier composites. Moreover, since the gas barrier composites of the present disclosure generally require low graphene nanoribbon concentrations, their transparency can be retained.

As such, the gas barrier composites of the present disclosure can find numerous applications. For instance, in some embodiments, the gas barrier composites of the present disclosure can find applications in product packaging (e.g., food packaging) and light-weight mobile gas storage containers. Additional applications of the gas barrier composites of the present disclosure can include, without limitation, use inflatable rafts, inflatable slides, children's play toys, inflatable roofs, inflatable signs, inflatable domes, inflatable boats, inflatable balloons for raising sunken structures, inflatable docks and piers, safety air bags for vehicles, blimps, weather balloons, balloons, and combinations thereof. In some embodiments, the gas barrier composites of the present disclosure can be used in gas tanks and gas cylinders, such as pressurized gas tanks and cylinders.

### ADDITIONAL EMBODIMENTS

Reference will now be made to more specific embodiments of the present disclosure and experimental results that provide support for such embodiments. However, Applicants note that the disclosure below is for illustrative purposes only and is not intended to limit the scope of the claimed subject matter in any way.

### Example 1

### Functionalized Low Defect Graphene Nanoribbons and Polyurethane Composite Films for Improved Gas Barrier and Mechanical Performances

A thermoplastic polyurethane (TPU) composite film containing hexadecyl-functionalized low-defect graphene nanoribbons (HD-GNRs) was produced by solution casting. The HD-GNRs were well distributed within the polyurethane matrix, leading to phase separation of the TPU. Nitrogen gas effective diffusivity of TPU was decreased by three orders of magnitude with only 0.5 wt % HD-GNRs. The incorporation of HD-GNRs also improved the mechanical properties of the composite films, as predicted by the phase separation and indicated by tensile tests and dynamic mechanical analyses.

The HD-GNRs were produced from in situ intercalation of Na/K alloy into multi-walled carbon nanotubes (MWNTS), followed by quenching with 1-iodohexadecane. The hexadecyl groups on the edges made the HD-GNRs easily dispersed in organic solvents. In addition, the HD-GNRs had a foliated structure that contributed to the gas impermeability of the composite films to gases.

TPU is comprised of linear block copolymers and is commonly used for coatings, adhesives, composites and biomedical applications. TPU is synthesized from alternating hard and soft segments formed by the reaction of diisocyanates with diols. The soft segments are composed of long chain polyester and polyether diols and the hard segments consist of diisocyanates and short chain extender molecules.

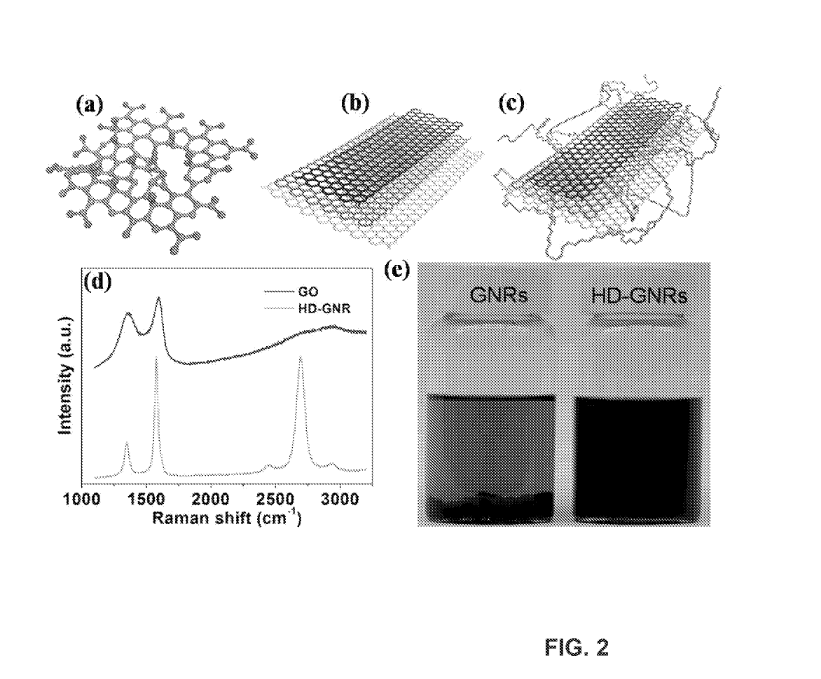

The structures of graphene oxide (GO), GNRs and HD-GNRs are shown in FIGS. 2A-C. Due to the chemical exfoliation methods for producing GO, GO has a variety of oxygen functional groups and physical defects in the basal plane that can result in unwanted gas diffusion. For GNRs, the graphitic structures are mainly preserved with a low concentration of defects. However, the problem with using GNRs as nanocomposite fillers is their poor dispersion in organic solvents.

To address these issues, HD-GNRs were synthesized (the hexadecyl aliphatic chains are orange in FIG. 2C). HD-GNRs have preserved graphitic domains with lower defect concentration than GO, as was confirmed by Raman spectroscopy (FIG. 2D). The G/D ratio of HD-GNRs is much higher than that in GO. In addition, the 2D peak of HD-GNRs was quite apparent, indicating good graphitic structure. However, no 2D peak was observed in GO due to the defects and heavy oxidation of its basal plane.

The solubility of GNRs and HD-GNRs in chloroform was tested and is shown in FIG. 2E. The mixtures were the same concentration (1 mg/mL) and were sonicated for 5 minutes. The GNRs started to precipitate after 10 minutes while the HD-GNRs were solution stable for 2 days.

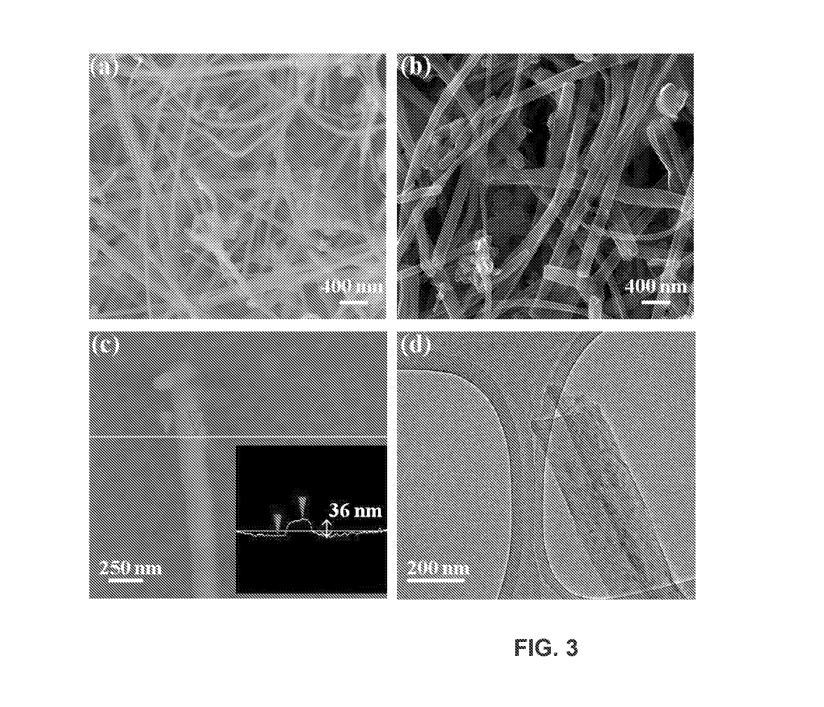

As noted, the HD-GNRs were derived from MWNTs. Scanning electron microscopy (SEM) images of MWNTs and HD-GNRs are shown in FIGS. 3A-B. The flattened ribbon structures are 200 to 300 nm in width, a dramatic change from the MWNTs (80 nm). Atomic force microscopy (AFM) measurement (FIG. 3C) indicates the thickness of the HD-GNRs was 36 nm, showing that they remain foliated, as observed in the past. A transmission electron microscopy (TEM) image of the HD-GNRs is shown in FIG. 3D.

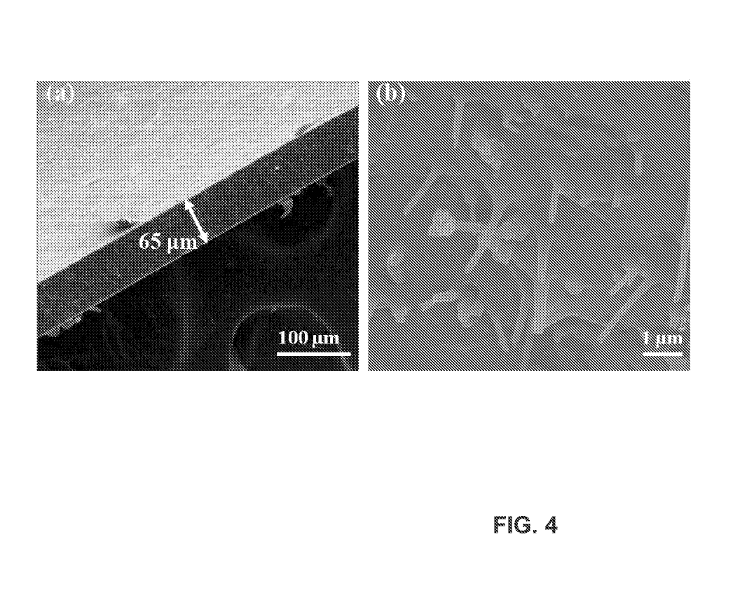

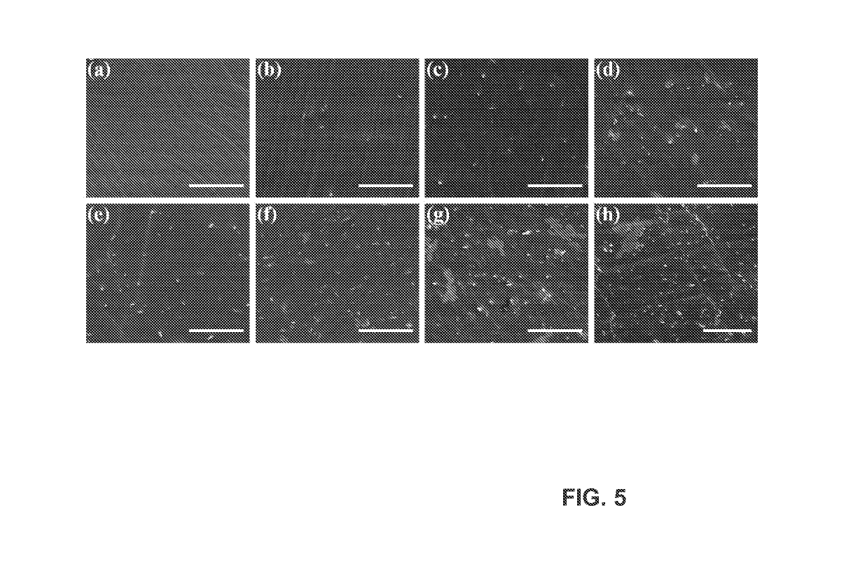

The composite films were made by solution casting (Examples 1.1-1.2). FIG. 4A is a cross sectional SEM image of a TPU/5 wt % HD-GNRs composite film after sputtering 5-nm-thick gold on its surface for imaging. FIG. 4B is a high resolution image of the same sample showing that the HD-GNRs are well-distributed within the TPU matrix. SEM images of TPU composite films at other HD-GNRs concentrations are shown in FIG. 5.

Adding nanoparticles to the TPU matrix can cause a phase separation of the hard and soft segments of the polymer due to the inter-domain interface and related free energy and entropy changes. This has been observed when nanoclays, carbon nanotubes and GO were added to TPU.

Phase separation was also detected in this Example. The most common method for characterization of TPU phase separation is by Fourier-transform infrared (FTIR) spectroscopy to observe the C═O stretching within the hard segments of TPU. These C═O can either form hydrogen bonds with the N—H groups in the hard segments or be non-hydrogen bonded. The more hydrogen bonding, the higher the level of phase separation of the TPU. In the FTIR spectrum, the hydrogen bonded C═O appears at 1697 cm⁻¹ while the free C═O stretching peaks at 1714 cm⁻¹.

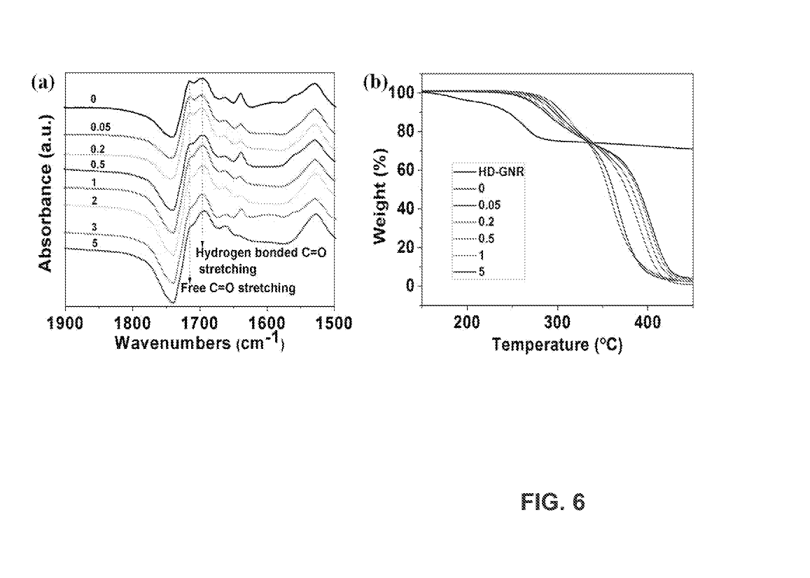

FTIR spectra of a TPU control and the composite samples are shown in FIG. 6A. As the concentration of HD-GNRs increased, the intensity ratio of hydrogen bonded C═O to free C═O increased, indicating the occurrence of phase separation.

Thermal stabilities of these composite films were characterized by thermogravimetric analysis (TGA). Interestingly, the thermal stability of TPU decreased while being heated from 250 to 340° C. and then increased from 340 to 500° C. Without being bound by theory, it is envisioned that the decrease in thermal stability in the first temperature range may come from the thermal decomposition of HD-GNRs functional groups. The HD-GNRs control sample suffered a dramatic weight loss that started at 150° C., and reached equilibrium after 300° C.

Another reason for the weight loss may be due to phase separation. The decomposition of TPU has two stages: the hard segment decomposes in the first stage and the soft segment decomposes in the second stage. When these two segments are mixed, the soft segment will have an inhibiting effect on the hard segment. However, phase separation isolates the segments and reduces the inhibiting effect. Thus, the thermal degradation increases as the phase separation increases in the early temperature range. In the second temperature range, the thermal stability increased at higher phase separations due to the lack of residual hard segments.

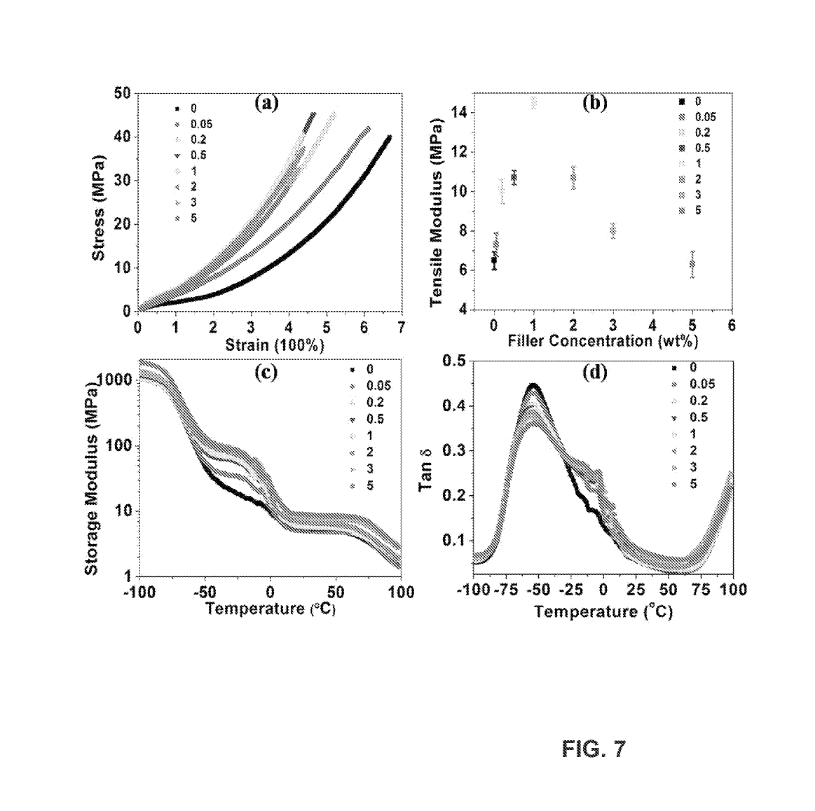

The mechanical properties of the composite films were characterized with static tensile tests and dynamic mechanical analysis (DMA). The stress-strain curves of the samples are shown in FIG. 7A as a function of increasing HD-GNR weight fraction with a maximum observed at 0.5 wt % HD-GNR. Higher HD-GNR concentrations resulted in stress concentration, which led to a decrease in fracture stress. The tensile moduli of these samples are summarized in FIG. 7B, and the reinforcing effects of HD-GNRs on the modulus are similar to the stress level. The modulus increased and peaked at 1 wt % HD-GNRs, and then gradually decreased upon further filler additions.

DMA testing was carried out from −100 to 100° C., and the storage modulus with respect to the temperature is shown in FIG. 7C. The reinforcing effect of HD-GNRs on the TPU is apparent and higher HD-GNRs concentration led to higher storage modulus. As shown in FIG. 7D, Tan δ (loss modulus/storage modulus) peaks decease as more HD-GNRs were added. Such results indicate that the presence of HD-GNRs within the TPU matrix lowers damping capacity. In addition, the peaks at −60 to 50° C. are associated with the glass transition temperature (Tg) of the soft phase of the TPU.

Without being bound by theory, it is envisioned that adding fillers to the polymer matrix should shift Tg to higher temperatures because the filler would restrict local polymer motions. However, the Tg of TPU was shifted to lower temperatures while adding HD-GNRs in this Example. This is because phase separation of TPU causes fewer hard segments to be alongside soft segments, so that the motion of the soft segment becomes easier. The hindering effect of hard segments plays a more important role than that of HD-GNRs in determining Tg shift. This result has been observed in TPU/carbon nanotube composites.

The N₂ gas permeability of the TPU/HD-GNR films was characterized by measuring the time necessary for a known amount of gas at ambient conditions to diffuse through the film into a dynamic vacuum (i.e. a vacuum with a pressure of <3×10⁻³ mbar). The pressure drop was measured by a gas-type independent capacitive manometer. The reported effective diffusivities represent the average of three independent experiments for each sample, and the standard deviation was within ±5%.

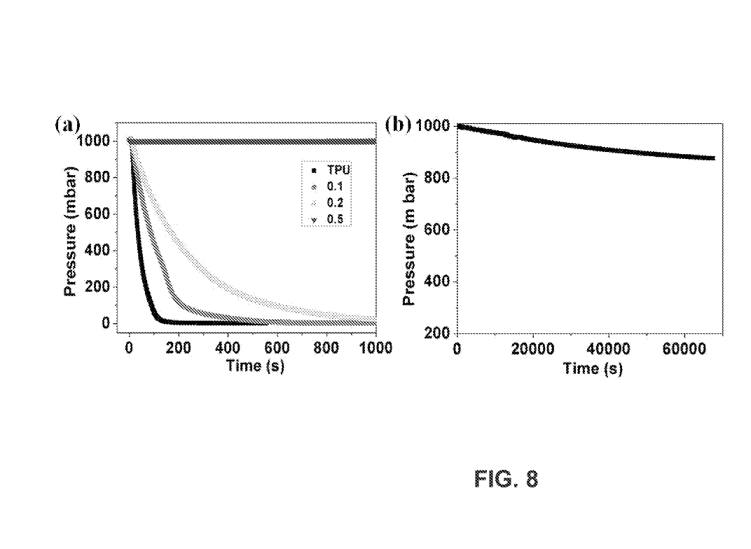

The pressure drop curves of TPU and TPU/HD-GNRs composite films are shown in FIG. 8A. The exponential decay function p(t)=C+P₀e^{-t/τ} was fitted to the pressure drop curves, where p(t) is the measured pressure (mbar), C is a constant, P₀ is the initial pressure in the reservoir (mbar), t is the time (s) and τ is the time constant of the pressure drop. The effective diffusivity D_{eff} (m²/s) of the gases was calculated from the time constant according to D_{eff}=(Vᵤ 1)/(Aτ), where Vᵤ(m³) is the volume of the gas reservoir, 1 (m) is the thickness of the film and A (m²) is the area of the film.

For the TPU control sample, the total N₂ in the gas reservoir permeates through the film in about 100 seconds. When 0.1 wt % HD-GNRs was added, it took about 500 seconds for the N₂ to pass through. At 0.2 wt % HD-GNRs, the time increased to about 1000 seconds. Interestingly, no pressure drop was detected when TPU/0.5 wt % HD-GNRs film was tested over a period of 1000 seconds. This significant change was seen as an effect of the HD-GNRs at a threshold concentration that provides very torturous paths for the N₂ to travel. The TPU/0.5 wt % HD-GNRs film became nearly impermeable because the pressure drop was undetectable over a short period of time under the conditions used.

The pressure drop of the same sample over a longer time is shown in FIG. 8B. A pressure decrease to 875 mbar over 67000 seconds was detected. Samples with HD-GNRs higher than 0.5 wt % were similarly impermeable to N₂ under the applied experimental conditions.

The calculated effective diffusivities (D_{eff}) of these composites are summarized in Table 1. In addition, gas diffusivities of HD-GNRs are compared to the gas diffusivities of GO and nanoclays in Table 2. With 0.5 wt % HD-GNRs, the D_{eff} of the composite film was decreased by three orders of magnitude when compared to pristine TPU film.

TABLE 1
Effective diffusivities of TPU and TPU/HD-GNRs films.

| Sample name | D_{eff} (10⁻⁶m²/s) |
|---|---|
| TPU | 3.90 |
| TPU/0.1 wt % HD-GNRs | 1.47 |
| TPU/0.2 wt % HD-GNRs | 0.65 |
| TPU/0.5 wt % HD-GNRs | 2.97 × 10⁻³ |

TABLE 2
Gas diffusivity comparison.

| Barrier Material | Performance |
|---|---|
| GO | 80x decrease at 3 wt % filler (ref. 1) |
| Nanoclay | 14x decrease at 28 wt % filler (ref. 2) |
| HD-GNRs | 1000x decrease at 0.5 wt % filler |

(ref. 1): Chem. Mater. 2010, 22, 3441-3450.
(ref. 2): J. Membr. Sci. 2009, 337, 208-214.

To Applicant's knowledge, the composite's permeability decrease by at least three orders of magnitude indicates that the GNRs could be the best gas barrier filler material shown in the literature, and much better than GO (10× decrease at 3 wt %) and nanoclays (−14× decrease at 28 wt %). Without being bound by theory, it is envisioned that the optimal gas barrier performance of HD-GNRs can be attributed to the stacked low defect GNRs structure producing an impermeable material that increases the barrier efficiency. It is also envisioned that the optimal gas barrier performance of HD-GNRs can be attributed to the optimal distribution of the HD-GNRs within the polymer matrix.

In sum, HD-GNRs and TPU composite films were successfully made in this Example by solution casting, with HD-GNRs uniformly distributed within the TPU matrix. The incorporation of HD-GNRs produced TPU phase separation and enhanced the mechanical properties. The composite films also demonstrate high gas barrier efficiencies at low loadings, a result attributed to the structure of the low defect HD-GNRs and their uniform dispersion.

### Example 1.1

### Materials

Commercial biomedical grade aliphatic, polyether-based TPU (Tecoflex® EG 80A injection grade) was purchased from the Lubrizol Corporation (Ohio, USA). MWNTs were donated by Mitsui & Co. (lot no. 05072001K28). Chloroform was purchased from Sigma-Aldrich.

### Example 1.2

### Solution Casting of Composite Films

For gas permeation test samples, the total weight of the composite film was kept at 2 g at the different HD-GNR concentrations, so the weight of TPU and HD-GNR could be calculated accordingly. For a typical 0.1 wt % TPU/HDGNR composite film, HD-GNR (2 mg) was added to chloroform (10 mL), followed by cup sonication (Cole Parmer, model 08849-00) for 5 minutes. TPU (1.98 g) was added to the HD-GNR solution and the mixture was stirred for 2 hours to obtain a homogenous dispersion. The viscous solution was then poured into a homemade cylindrical steel mold (diameter=8 cm and depth=12 mm), and the mold was placed in a fume hood at room temperature for 10 hours to allow the solvent to slowly evaporate. For mechanical testing samples, the total weight was lowered to 1 g for easier testing.

### Example 1.3

### Mechanical Testing

Tensile testing was carried out using an Instron Electropuls E3000. The cross head strain rate was 100%/min. Dynamic mechanical analysis (DMA) was performed in a TA Instruments Q800 series apparatus in film tension mode. Film samples were rectangular and cut into dimensions of 15 mm×3.5 mm×0.08 mm. The temperature was ramped from −100 to 100° C. at a rate of 2° C./min, 1 Hz frequency and 1% strain in air. The force track was set to 150% and the preload force was set at 0.01 N. Data was analyzed with TA Instruments' Universal Analysis 2000 software package.

### Example 1.4

### Characterization Methods

SEM was performed on a FEI Quanta 400 high resolution field emission SEM. 5 nm Au was sputtered (Denton Desk V Sputter system) on the film surface before imaging. TEM images were taken using a 2100F field emission gun TEM with HD-GNR directly transferred onto a copper TEM grid. AFM image was obtained on a Digital Instrument Nanoscope IIIA AFM. Raman microscopy was performed with Renishaw Raman microscope using 514-nm laser excitation at room temperature. FTIR was measured using a Nicolet FTIR Infrared Microscope. TGA (Q50, TA Instruments) was carried out from 100° C. to 500° C. at 10° C./min under argon.

### Example 1.5

### Gas Permeation Testing

The measured diameter of the films was 14.45 mm. Membrane thickness was 190 micron. Gas reservoir volume was 129 cm³. The reported effective diffusivities represent the average of three independent experiments for each sample.

Gas permeability is usually used and reported for gas barrier characterizations. Applicants tested gas diffusivity in this Example. Permeability can be characterized by the following formula: P=DS, where P is the gas permeability, D is the gas diffusivity and S is the gas solubility. If the gas is non-reactive to the composite, as in this case, adding impermeable fillers into the polymer matrix usually decreases S due to the loss of volume available for sorption. Thus, the decrease of P should be at least as low as the decrease of D.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A gas barrier composite comprising:
a polymer matrix; and
graphene nanoribbons dispersed in the polymer matrix.

2. The gas barrier composite of claim 1, wherein the polymer matrix comprises a block copolymer.

3. The gas barrier composite of claim 1, wherein the polymer matrix comprises a phase-separated block copolymer.

4. The gas barrier composite of claim 3, wherein the phase-separated block copolymer comprises a hard phase domain and a soft phase domain.

5. The gas barrier composite of claim 1, wherein the polymer matrix is selected from the group consisting of styrenic block copolymers, polyolefin blends, elastomeric alloys, thermoplastic polyurethanes, poly(esters), thermoplastic co-poly(esters), thermoplastic polyamides, poly(vinyl alcohol), polyethylene terephthalate, polyethylene, polypropylene, high density polyethylene, poly(ethers), co-polymers thereof, block co-polymers thereof, and combinations thereof.

6. The gas barrier composite of claim 1, wherein the polymer matrix comprises thermoplastic polyurethane.

7. The gas barrier composite of claim 1, wherein the graphene nanoribbons comprise functionalized graphene nanoribbons.

8. The gas barrier composite of claim 7, wherein the functionalized graphene nanoribbons are selected from the group consisting of edge-functionalized graphene nanoribbons, polymer-functionalized graphene nanoribbons, alkyl-functionalization graphene nanoribbons, and combinations thereof.

9. The gas barrier composite of claim 7, wherein the functionalized graphene nanoribbons comprise polymer-functionalized graphene nanoribbons.

10. The gas barrier composite of claim 9, wherein the polymer-functionalized graphene nanoribbons are functionalized with polymers selected from the group consisting of vinyl polymers, polyethylene, polystyrene, polyvinyl chloride, polyvinyl acetate, polyvinyl alcohol, polyacrylonitrile, and combinations thereof.

11. The gas barrier composite of claim 7, wherein the functionalized graphene nanoribbons comprise alkyl-functionalized graphene nanoribbons.

12. The gas barrier composite of claim 11, wherein the alkyl-functionalized graphene nanoribbons are functionalized with alkyl groups selected from the group consisting of hexadecyl groups, octyl groups, butyl groups, and combinations thereof.

13. The gas barrier composite of claim 1, wherein the graphene nanoribbons comprise hexadecylated-graphene nanoribbons (HD-GNRs).

14. The gas barrier composite of claim 1, wherein the graphene nanoribbons are derived from carbon nanotubes.

15. The gas barrier composite of claim 1, wherein the graphene nanoribbons comprise a single layer.

16. The gas barrier composite of claim 1, wherein the graphene nanoribbons comprise a plurality of layers.

17. The gas barrier composite of claim 16, wherein the graphene nanoribbons comprise from about 2 layers to about 10 layers.

18. The gas barrier composite of claim 1, wherein the graphene nanoribbons comprise from about 0.1% by weight to about 5% by weight of the gas barrier composite.

19. The gas barrier composite of claim 1, wherein the graphene nanoribbons comprise about 0.5% by weight of the gas barrier composite.

20. The gas barrier composite of claim 1, wherein the gas barrier composite displays impermeability to a gas.

21. The gas barrier composite of claim 20, wherein the gas is selected from the group consisting of air, N₂, H₂, O₂, CH₄, CO₂, natural gas, H₂S and combinations thereof.

22. The gas barrier composite of claim 20, wherein the gas comprises N₂.

23. The gas barrier composite of claim 20, wherein the impermeability to the gas ranges from about 50% to about 100%.

24. The gas barrier composite of claim 20, wherein the impermeability to the gas is more than about 50%.

25. The gas barrier composite of claim 20, wherein the gas barrier composite has a gas effective diffusivity (D_{eff}) that ranges from about 1×10⁻³ m²/s to about 5×10⁻³ m²/s.

26. The gas barrier composite of claim 20, wherein the gas barrier composite has a gas effective diffusivity (D_{eff}) of about 3×10⁻³ m²/s.

27. The gas barrier composite of claim 1, wherein the gas barrier composite has a transparency of more than about 50%.

28. The gas barrier composite of claim 27, wherein the gas barrier composite has a transparency of more than about 50%, and wherein the graphene nanoribbons comprise from about 1 layer to about 4 layers.

29. The gas barrier composite of claim 27, wherein the gas barrier composite has a transparency of more than about 90%, and wherein the graphene nanoribbons comprise from about 1 layer to about 3 layers.

30. The gas barrier composite of claim 1, wherein the graphene nanoribbons have an isotropic arrangement in the polymer matrix.

31. The gas barrier composite of claim 1, wherein the graphene nanoribbons have an anisotropic arrangement in the polymer matrix.

32. The gas barrier composite of claim 1, wherein the gas barrier composite consists essentially of graphene nanoribbons and a polymer matrix.

33. The gas barrier composite of claim 1, wherein the gas barrier composite lacks graphene oxide.

34. The gas barrier composite of claim 1, wherein the gas barrier composite lacks nanoclays.

35. A method of making gas barrier composites, said method comprising:
dispersing graphene nanoribbons in a polymer matrix,
wherein the dispersing lowers permeability of a gas through the gas barrier composite.

36. The method of claim 35, wherein the dispersing occurs by a method selected from the group consisting of blending, stirring, thermal melting, layering, extrusion, sonication, solution casting, shearing, and combinations thereof

37. The method of claim 35, wherein the polymer matrix comprises a block copolymer, and wherein the dispersing causes phase separation of the block copolymer.

38. The method of claim 37, wherein the dispersing causes phase separation of the block copolymer into a soft phase domain and a hard phase domain.

39. The method of claim 35, wherein the polymer matrix is selected from the group consisting of styrenic block copolymers, polyolefin blends, elastomeric alloys, thermoplastic polyurethanes, poly(esters), thermoplastic co-poly(esters), thermoplastic polyamides, poly(vinyl alcohol), polyethylene terephthalate, polyethylene, polypropylene, high density polyethylene, poly(ethers), co-polymers thereof, block co-polymers thereof, and combinations thereof.

40. The method of claim 35, wherein the polymer matrix comprises thermoplastic polyurethane.

41. The method of claim 35, wherein the graphene nanoribbons comprise functionalized graphene nanoribbons.

42. The method of claim 41, wherein the functionalized graphene nanoribbons are selected from the group consisting of edge-functionalized graphene nanoribbons, polymer-functionalized graphene nanoribbons, alkyl-functionalization graphene nanoribbons, and combinations thereof.

43. The method of claim 41, wherein the functionalized graphene nanoribbons comprise polymer-functionalized graphene nanoribbons, wherein the polymer-functionalized graphene nanoribbons are functionalized with polymers selected from the group consisting of vinyl polymers, polyethylene, polystyrene, polyvinyl chloride, polyvinyl acetate, polyvinyl alcohol, polyacrylonitrile, and combinations thereof.

44. The method of claim 41, wherein the functionalized graphene nanoribbons comprise alkyl-functionalized graphene nanoribbons, wherein the alkyl-functionalized graphene nanoribbons are functionalized with alkyl groups selected from the group consisting of hexadecyl groups, octyl groups, butyl groups, and combinations thereof.

45. The method of claim 35, wherein the graphene nanoribbons comprise hexadecylated-graphene nanoribbons (HD-GNRs).

46. The method of claim 35, wherein the graphene nanoribbons are derived from carbon nanotubes.

47. The method of claim 35, wherein the graphene nanoribbons comprise from about 0.1% by weight to about 5% by weight of the gas barrier composite.

48. The method of claim 35, wherein the graphene nanoribbons comprise about 0.5% by weight of the gas barrier composite.

49. The method of claim 35, wherein the graphene nanoribbons have an isotropic arrangement in the polymer matrix.

50. The method of claim 35, wherein the graphene nanoribbons have an anisotropic arrangement in the polymer matrix.

51. The method of claim 35, wherein the dispersion of graphene nanoribbons in the polymer matrix lowers a gas effective diffusivity (D_{eff}) of the gas barrier composite by at least three orders of magnitude.

52. The method of claim 35, wherein the dispersion of graphene nanoribbons in the polymer matrix lowers a gas effective diffusivity (D_{eff}) of the gas barrier composite to a value that ranges from about 1×10⁻³ m²/s to about 5×10⁻³ m²/s.

53. The method of claim 35, wherein the dispersion of graphene nanoribbons in the polymer matrix lowers a gas effective diffusivity (D_{eff}) of the gas barrier composite to a value of about 3×10⁻³ m²/s.

54. The method of claim 35, wherein the gas is selected from the group consisting of air, N₂, H₂, O₂, CH₄, CO₂, natural gas, H₂S, and combinations thereof.

55. The method of claim 35, wherein the gas comprises N₂.
